(19) United States
(12) Patent Application Publication
(10) Pub. No.: US 2016/0266332 A1
(43) Pub. Date: Sep. 15, 2016

(54) OPTICAL DIE PACKAGING

(71) Applicant: Global Foundries Inc., Grand Cayman (KY)

(72) Inventors: Benjamin Fasano, New Windsor, NY (US); Paul Fortier, Richelieu (CA)

(21) Appl. No.: 14/643,323

(22) Filed: Mar. 10, 2015

(51) Int. Cl. G02B 6/42; G02B 6/30; G02B 6/122

(52) U.S. Cl. CPC G02B 6/4206; G02B 6/122; G02B 6/4274; G02B 6/30; G02B 2006/12142

(57) ABSTRACT

An optical package includes a laser die a photonics die. The laser die generates light and includes a laser facet that emits light. The photonics die modulates light emitted from the facet and includes an internal waveguide optically connected with the facet and one or more standoff contacts, flush contacts, or reduced contacts. The optical package may also include an external waveguide optically connected to the photonics die. The external waveguide may be optically connected to the photonics die prior to electrically connecting the photonics die with an interposer. The standoff contacts extend from a device side of the photonics die beyond the laser die, the flush contacts extend from the device side of the photonics die to be coplanar with the laser die, and the reduced contacts extend from the device side of the photonics short of the laser die.

### FIELD

Embodiments of invention generally relate to semiconductor devices and semiconductor device packaging. More particularly, embodiments relate to packaging a laser die and a photonics die to create an optical die package.

### BACKGROUND

Semiconductor Photonics is the study and application of photonic systems which use a semiconductor, such as silicon, as an optical medium. The semiconductor is usually patterned with sub-nanometer precision, into components that may operate in the infrared wavelengths, used by most fiber optic telecommunication systems. The semiconductor typically lies on top of a layer of silica, also known as silicon on insulator (SOI) fabrication, and is packaged into a photonics die.

The photonics die receives light from a continuous wavelength laser. This laser light source can be either physically attached to the photonics die delivering light directly to the phonics die or be positioned separate from the die. When off-die lasers are used, light from the laser can be fed into the photonics die by the use of glass fibers or other waveguide materials such as a polymer. Light, thus introduced into the photonics die waveguide input, becomes encoded data, by electronically modulating the light in the form of optical pulses. The optical pulses pass through additional optical components and finally to a waveguide output that may transmit, light pulse data to an adjacent optically connected device or a different photonics system.

### SUMMARY

In an embodiment of the present invention, an optical package includes a laser die and a photonics die. The laser die generates light and includes a light emitting facet. The photonics die modulates light emitted from the light emitting facet and includes an internal waveguide optically connected with the laser facet and a plurality of standoff, flush, or reduced contacts.

In another embodiment of the present invention, an optical packaging method includes optically connecting and electrically connecting a device side surface of a laser die to a device side surface of a photonics die that includes an internal waveguide and a plurality of standoff contacts extending from the photonics die device side surface and adiabatically coupling an external waveguide with the photonic die internal waveguide.

These and other embodiments, features, aspects, and advantages will become better understood with reference to the following description, appended claims, and accompanying drawings.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts an exemplary optical die package, in accordance with various embodiments of the present invention.

FIG. 2 depicts various views of an exemplary optical die package at a stage of optical die package fabrication, in accordance with various embodiments of the present invention.

FIG. 3 depicts various views of an exemplary optical die package at a stage of optical die package fabrication, in accordance with various embodiments of the present invention.

FIG. 4 depicts various views of an exemplary optical die package at a stage of optical die package fabrication, in accordance with various embodiments of the present invention.

FIG. 5-FIG. 6 depict side views of an exemplary optical die package at stages of optical die package fabrication, in accordance with various embodiments of the present invention.

FIG. 7 depicts various views of an exemplary optical die package at a stage of optical die package fabrication, in accordance with various embodiments of the present invention.

FIG. 8 depicts various views of an exemplary optical die package at a stage of optical die package fabrication, in accordance with various embodiments of the present invention.

FIG. 9 depicts various views of an exemplary optical die package at a stage of optical die package fabrication, in accordance with various embodiments of the present invention.

FIG. 10-FIG. 14 depict side views of an exemplary optical die package at stages of optical die package fabrication, in accordance with various embodiments of the present invention.

FIG. 15 depicts an exemplary waveguide, in accordance with various embodiments of the present invention.

FIG. 16-FIG. 17 depict exemplary optical packaging methods, in accordance with various embodiments of the present invention.

FIG. 18 depicts a block diagram of a design flow used in semiconductor integrated circuit logic design, simulation, test, layout, and/or manufacture, in accordance with various embodiments of the present invention.

The drawings are not necessarily to scale. The drawings are merely schematic representations, not intended to portray specific parameters of the invention. The drawings are intended to depict only exemplary embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. These exemplary embodiments are provided so that this disclosure will be thorough and complete and will fully convey the scope of this invention to those skilled in the art. In the description, details of well-known features and techniques may be omitted to avoid unnecessarily obscuring the presented.

Various embodiments of invention relate to semiconductor devices and semiconductor device packaging, and specifically relate to fabricating an optical die package. The optical die package includes a photonics die, a laser die, and an external waveguide. An optical interconnect is achieved by adiabatic coupling the package waveguide to the external die.

Referring now to the figures, wherein like components are labeled with like numerals, exemplary embodiments of the present invention are shown and will now be described in greater detail below. It should be noted that while this description may refer to some components in the singular tense, more than one component may be depicted throughout the figures. The specific number of components depicted in the figures and the cross section orientation was chosen to best illustrate the various embodiments described herein.

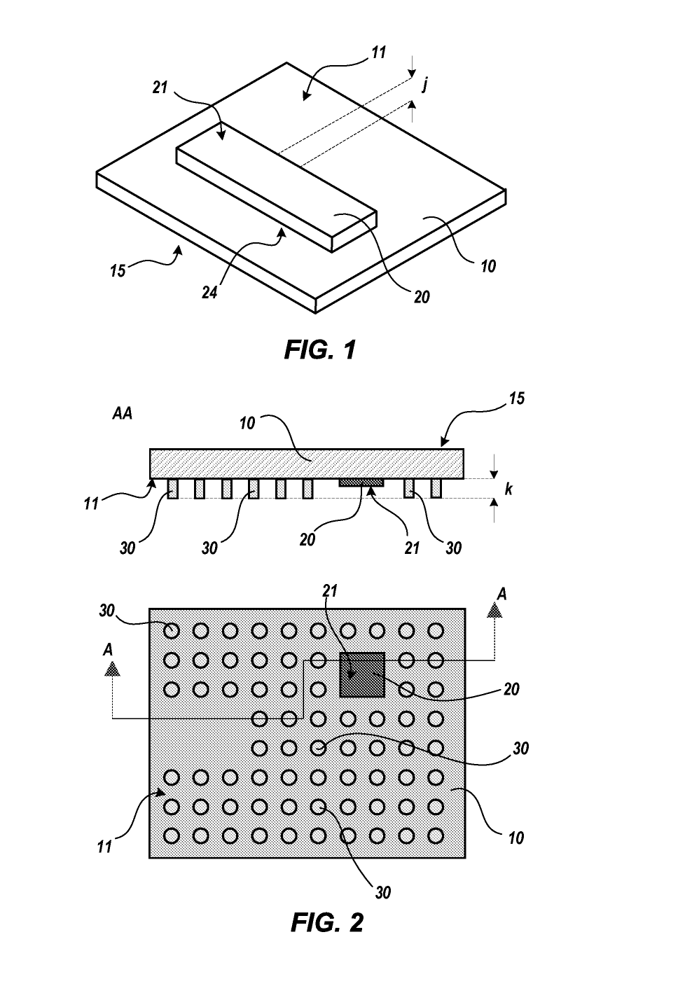

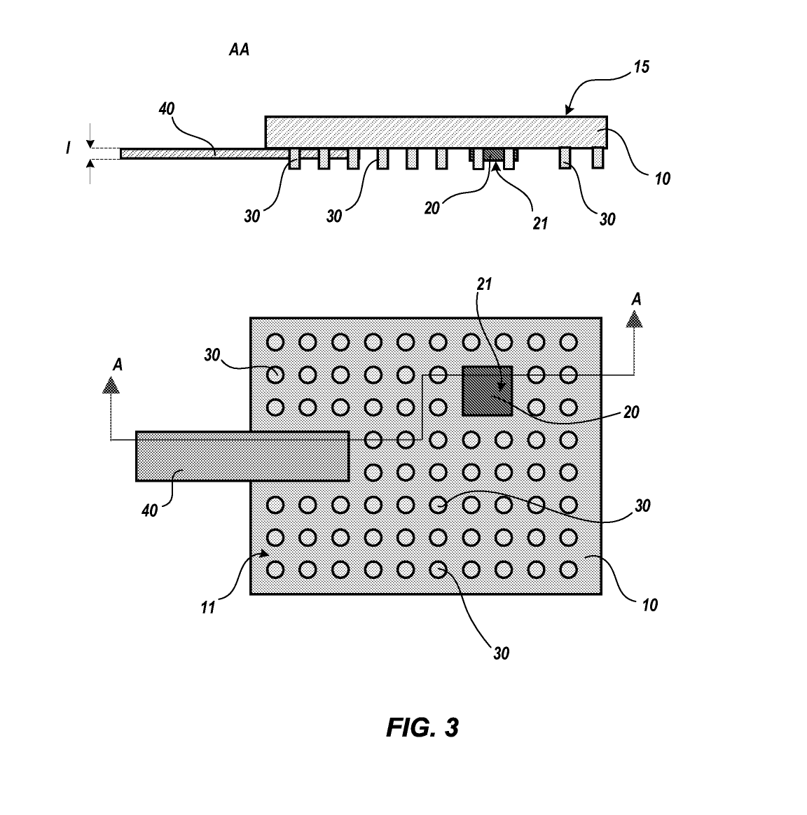

FIG. 1 depicts a laser die 20 attached with a photonics die 10, in accordance with various embodiments of the present invention, that forms an optical package. Generally, laser die 20 is electrically connected and optically connected with photonics die 10. Electrically connected shall mean that electrical current is capable from passing from laser die 20 to photonics die 10. Likewise, optically connected shall mean that light is capable from passing from laser die 20 to photonics die 10. Photonics die 10 receives light from laser die 20 with internal waveguides upon device side surface 11 or embedded below the device side surface 11 of photonics die 10. Photonics die 10 also includes surface 15 that opposes device side surface 11 and using surface and embedded electro-optic devices, encodes data by modulating the received laser light into optical pulses. The optical pulses pass through an internal waveguide output and are transmitted by the external waveguide 40 (shown in FIG. 3) connected to the photonics die 10. In some embodiments, photonics die 10 further includes thru vias and/or other contacts exposed upon surface 15 such that yet another die may be mounted thereto so as to provide e.g., additional computing capability, etc.

In various embodiments, a device side surface 24 of laser die 20 is attached with the device surface 11 of photonics die 10. In a particular embodiment, the laser die 20 may be electrically connected to photonics die 10 by wire bonds. The particular electrical connection between the laser die 20 and photonics die 10 (e.g., wire, C4s, solder, stud, pin, button, array, etc.) may be chosen to minimize the dimension “j” between surface 21 of laser die that opposes device side surface 24 and device side surface 11 of photonics die 10. In an exemplary embodiment, the dimension “j” may be approximately 100 μm. An underfill may be applied between the laser die 20 and the photonics die subsequent to the optical connection and electrical connection there between.

The photonics die 10 and laser die 20 may be included in a data handling system, computer, etc. Exemplary major components of such system may include one or more processors, a main memory, a terminal interface, a storage interface, an I/O (Input/Output) device interface, and a network adapter, all of which are communicatively coupled, directly or indirectly, for inter-component communication via a bus. In a particular implementation the photonics die 10 may be communicatively connected to the bus to receive data from the processor. The photonics die 10 may modulate the received data into light pulses that may be sent via at least in part the external waveguide 40 to an optical network adapter, optical cable, etc., to a receiving data handling system. A photonics die 10 within the receiving data handling system may receive the optical pulses and modulate the light pulses back to the data for further data processing (e.g. storage within the receiving data handling system, etc.).

The internal waveguides may be e.g. a photonic waveguides, slot waveguides, rib waveguides, etc. and may include a waveguide region adjacent p-and n- doped regions generally positioned upon or below surface 11 of photonics die 10. P region and N region contacts essentially form terminals of a p-i-n diode, between the waveguide region. Electrical current may be provided to P region and N region contacts to alter the optical properties of the waveguide region. Such alterations may provide for the modulation of light provided by laser die 10 into light pulses. In certain embodiments, photonics die 10 includes a single or multiple internal waveguides.

Generally, laser die 20 is the source of light to photonics die 10. In certain embodiments, laser die 20 may be a bare laser die often referred to as a distributed feedback laser, a laser diode chip, etc. The light generated by laser die 20 may be transferred to a light emitting edge and emitted at one or more facets. Laser die 20 may produce various wavelengths of light. The various wavelengths of light may be transferred to photonics die 20 by a single facet or by multiple facets. When laser die 20 is attached to photonics die 10, light generated by laser die 20 is transferred to respective internal waveguides of photonics die 10 via an associated facet.

Subsequent to the attachment of laser die 20 and photonics die 10 adhesive or underfill may be dispensed generally around laser die 20. Capillary action may draw the material between the laser die 20 and photonics die 10 interface. The material may be subsequently cured and may also provide for a thermal interface between laser die 20 and photonics die 10. In various embodiments, a force may be applied between laser die 20 and photonics die 10 during curing for proper attachment of laser die 20 with photonics die 10.

As shown in FIG. 2, photonics die 10 may further include standoff contacts 30 electrically connected to photonics die 10. FIG. 2 depicts the optical package device side surface 11 and side view along plane AA. Standoff contacts 30 have a height “k” greater than the height “1” of external waveguide 40. Standoff contacts 30 may be pillars, studs, pins, solder balls, etc. Though shown cylindrical shaped, standoff contacts 30 may be rectangular, polygonal, etc. Standoff contacts 30 are electrically conductive. For example, standoff contacts 30 may be copper. Standoff contacts 30 may be attached to respective contacts of photonics die 10. Standoff contacts 30 generally enable electrical current to be provided from photonics die 10 to laminate 50. Standoff contacts 30 may be metal, copper, gold, etc.

As shown in FIG. 3, the optical package may further include an external waveguide 40 optically connected to device side surface 11 of photonics die 10. FIG. 3 depicts the optical package device side surface 11 and side view along plane AA. One or more waveguides within external waveguide 40 are optically connected to associated internal waveguides of photonics die 10 by adiabatic coupling. As such, light may transfer from an internal waveguide of photonics die 10 to an adiabatic coupled waveguide within external waveguide 40. In an exemplary embodiment, the dimension “1” may be approximately 100 μm.

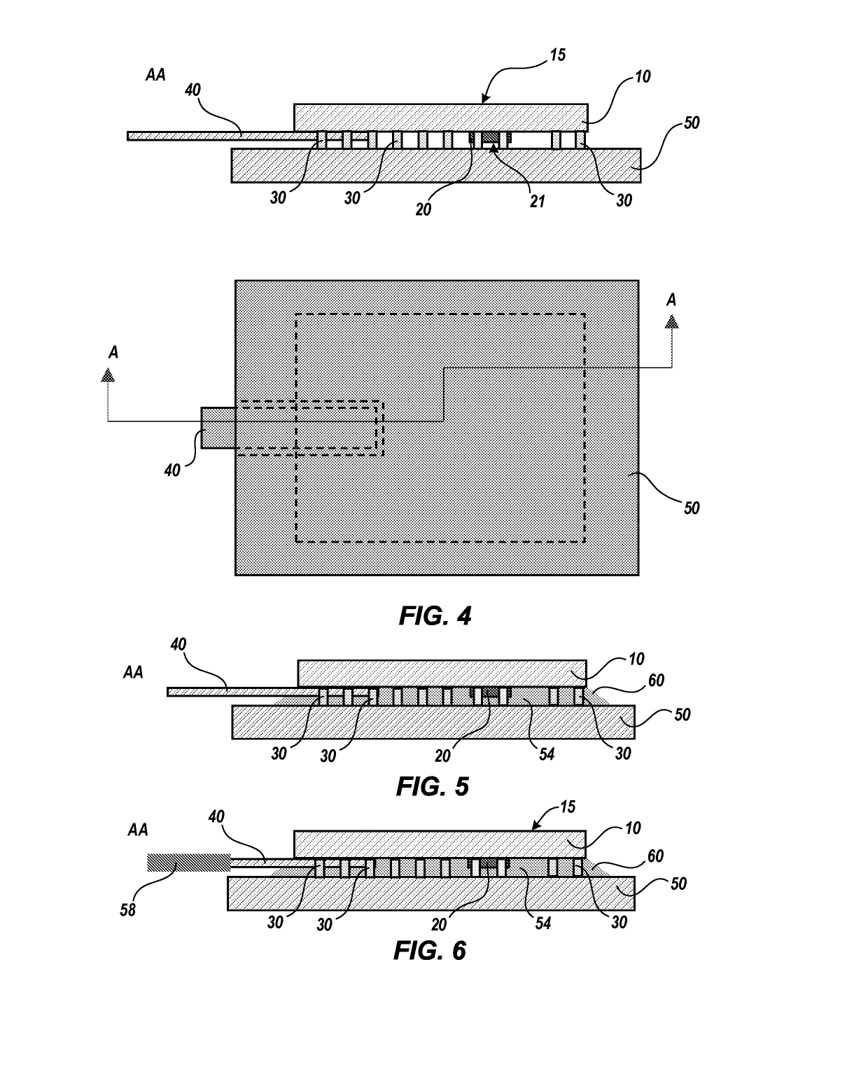

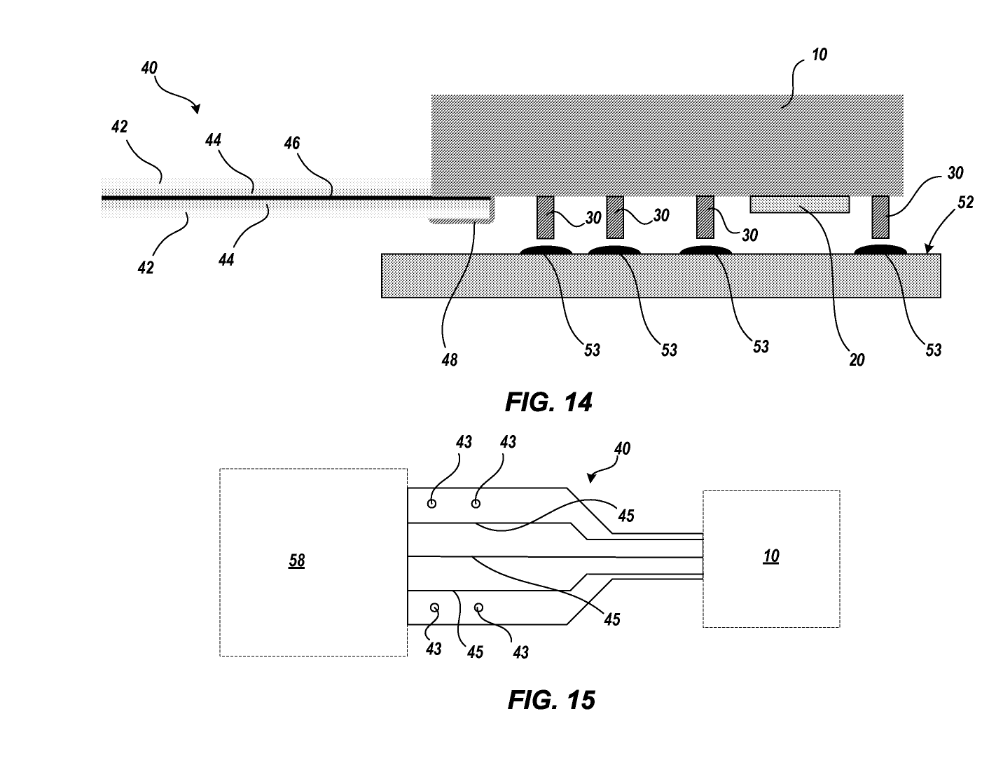

As shown in FIG. 4, the optical package may further include interposer 50. FIG. 4 depicts the optical package device side surface 11 and side view along plane AA. Photonics die 10 may be electrically connected to interposer 50 by connecting (soldering, seating, etc.) standoff contacts 30 with respective contacts 53 on first side 52, as is exemplary shown in FIG. 14. Interposer 50 may include a first side 52 having one or more contacts and a second side 54 having one or more contacts. The first side 52 and second side 54 contacts are electrically interconnected by an electrical conducting material within interposer 50. The optical package may subsequently be installed to the data handling system, computer, etc. by connecting the contacts on side 54 and respective contacts upon the system board of the data handling system, computer, etc.

As shown in FIG. 5, an adhesive or underfill material 60 may be applied between the optical package and interposer 50. FIG. 5 depicts the optical package side view along plane AA. Subsequent to the attachment of photonics die 10 and interposer 50, adhesive or underfill 60 may be applied between the optical package and the interposer 50 interface. For example, the adhesive or underfill 60 may fill air gaps that exist between the interposer 50 and external waveguide 40 and between the interposer and photonics die 10 surrounding standoff contacts 30. The material 60 may be subsequently cured and may also provide for a thermal interface between photonics die 10 and interposer 50. The adhesive or underfill material 60 between external waveguide 40 and interposer 50 also may serve to reduce strain on the connection between waveguide 40 and photonics die 10. In various embodiments, a force may be applied between the optical package and interposer 50 during curing. In certain embodiments, at the present stage of optical package fabrication, the optical package may be tested (e.g. the external waveguide 40 may be optically attached to an optical test socket, etc.).

As shown in FIG. 6, an optical fiber ferrule 58 is optically attached to external waveguide 40. FIG. 6 depicts the optical package side view along plane AA. The Ferrule 58 is an optical fiber coupler to external waveguide 40. For example, ferrule 50 is an interface between optical fibers and respective waveguides within external waveguide 40. Optical fibers may be optically connected (e.g., butt-coupled, etc.) to ferrule 58. The optical fibers may be connected to an optical network so that modulated light may be sent or received to or from the optical package from or to another data handling system.

In certain embodiments, backside 15 of photonics die 10 may be in thermal contact with a heat dissipating device (e.g. heat sink, thermal interface material, etc.) to remove heat from photonics die 10. For example, heat generated by laser die 20 may flow generally from device side 24 of laser die 20, transfer to photonics chip 10 and flow generally from device side 11 to backside 15, and transfer to the heat dissipating device.

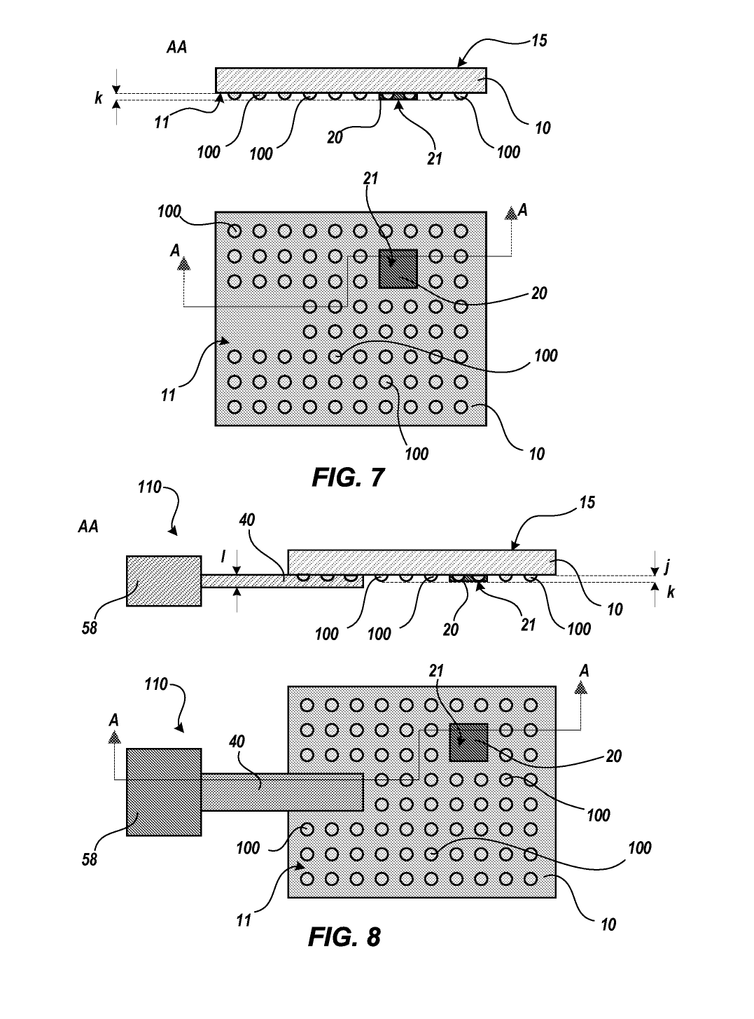

As shown in FIG. 7, photonics die 10 may include flush/recessed (FR) contacts 100 electrically connected to photonics die 10. FIG. 7 depicts the optical package device side surface 11 and side view along plane AA. FR contacts 100 have a height “k” equal to or less than the height “j” of laser die 20. FR contacts 100 may be pillars, studs, pins, etc. Though shown spherical shaped, FR contacts 100 may be rectangular, polygonal, etc. FR contacts 100 are electrically contact to respective contacts of photonics die 10. FR contacts 100 generally enable electrical current to be provided from photonics die 10 to laminate 50. FR contacts 100 may be metal, copper, gold, etc.

As shown in FIG. 8, the optical package may further include a ferruled external waveguide 110 optically connected to device side surface 11 of photonics die 10. FIG. 8 depicts the optical package device side surface 11 and side view along plane AA. Ferruled external waveguide includes external waveguide 40 and ferrule 58. The height “1” of waveguide 40 is greater than the height “j” of laser die 20 and the height “k” of FR contacts 100. One or more waveguides within external waveguide 40 are optically connected to associated internal waveguides of photonics die 10 by adiabatic coupling. As such, light may transfer from an internal waveguide of photonics die 10 to an adiabatic coupled waveguide within external waveguide 40.

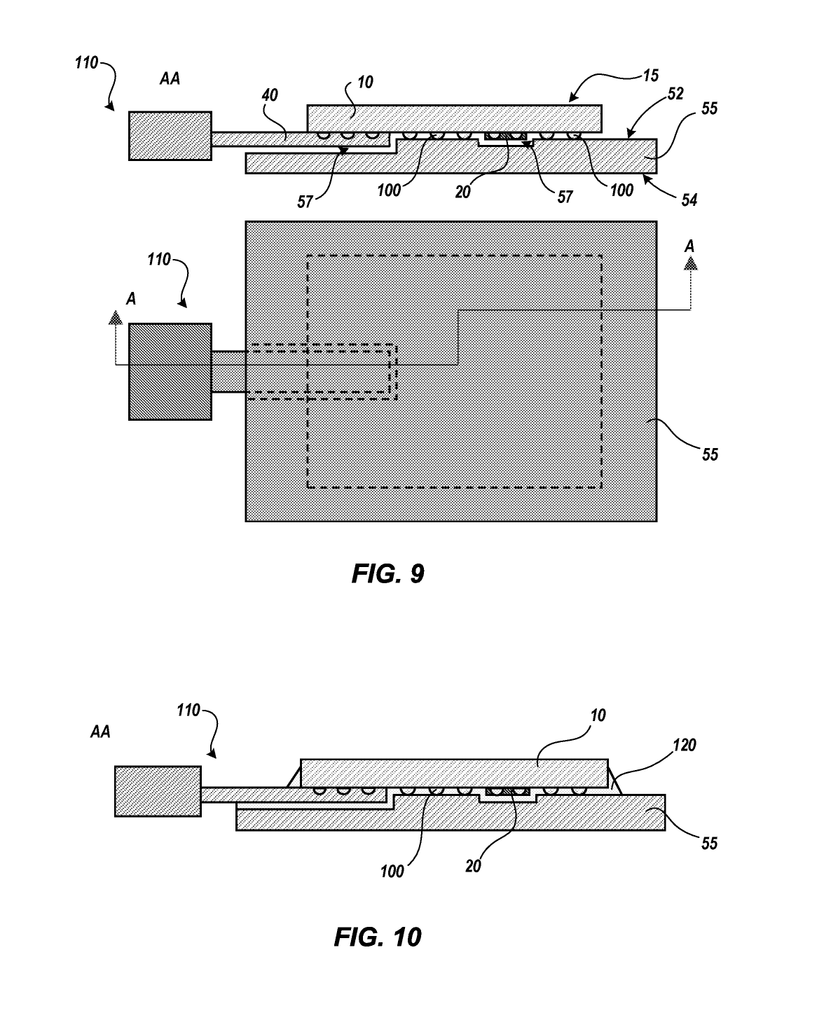

As shown in FIG. 9, the optical package may further include recessed interposer 55. FIG. 9 depicts the optical package device side surface 11 and side view along plane AA. Recessed interposer 55 includes one or more recesses 57 or reliefs for laser die 20 and/or external waveguide 40 so that FR contacts 100 may contact surface 52. Recessed interposer 55 may be utilized e.g., when the height “j” of laser die 20 and/or when the height “1” of external waveguide 40 is greater than or similar to the fabrication limit height “k” of e.g., contacts 30. Photonics die 10 may be electrically connected to recessed interposer 55 by connecting (soldering, seating, etc.) FR contacts 100 with respective contacts 53 on first side 52. Recessed interposer 55 may include a first side 52 having one or more contacts and a second side 54 having one or more contacts. The first side 52 and second side 54 contacts are electrically interconnected by an electrical conducting material within recessed interposer 55. The optical package may subsequently be installed to the data handling system, computer, etc. by connecting the contacts on side 54 and respective contacts upon the system board of the data handling system, computer, etc.

As shown in FIG. 10, an adhesive or underfill material 120 may be applied between the optical package and recessed interposer 55. FIG. 10 depicts the optical package side view along plane AA. Subsequent to the attachment of photonics die 10 and recessed interposer 55, adhesive or underfill may be applied between the optical package and recessed interposer 55 interface. For example, the adhesive or underfill may fill air gaps that exist between recessed interposer 55 and external waveguide 40 and between the interposer and photonics die 10 surrounding FR contacts 100. The material may be subsequently cured and may also provide for a thermal interface between photonics die 10 and interposer 55. The adhesive or underfill material between external waveguide 40 and interposer 55 also may serve to reduce strain on the connection between waveguide 40 and photonics die 10. In various embodiments, a force may be applied between the optical package and interposer 55 during curing.

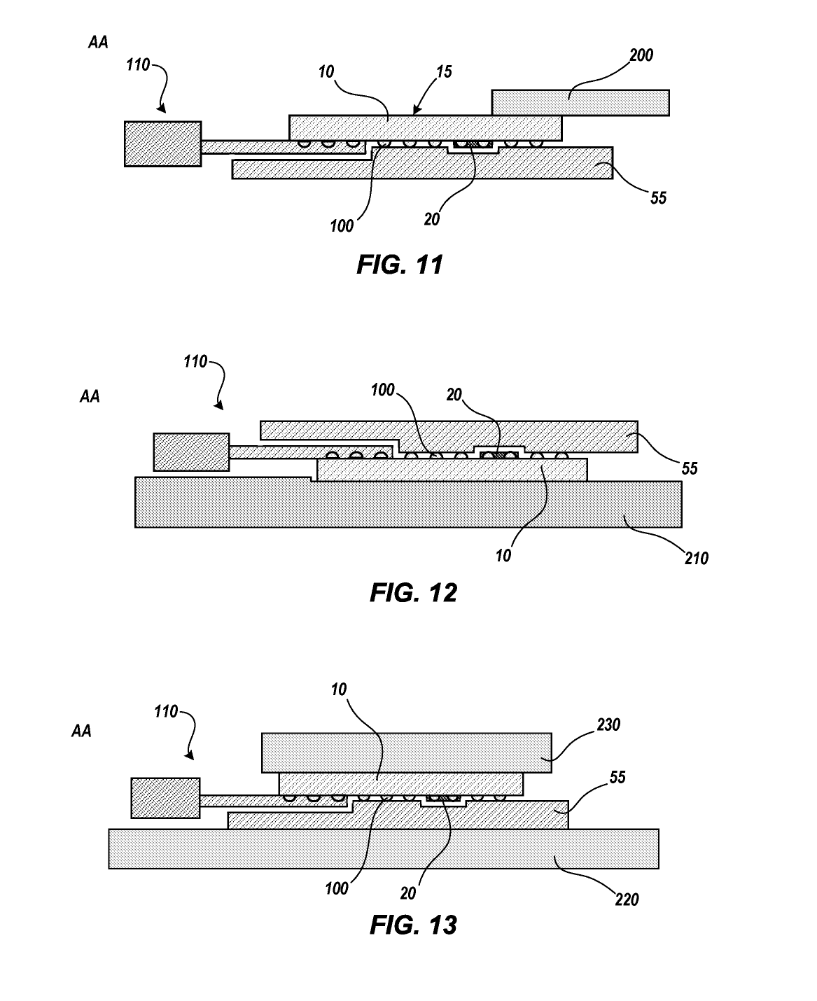

As shown in FIG. 11, a counter balance 200 may be applied to side surface 15 of photonics die 10 during the electrical connection of photonics die 10 with the interposer to prevent the weight of external waveguide 40, etc. causing improper electrical connections between contacts 30, 100 and the interposer. As shown in FIG. 12, a vacuum/tray 210 may be applied to side surface 15 of photonics die 10 to planarize side surface 11 of photonics die 11 such that accurate electrical connections between contacts 30, 100 may be achieved. As shown in FIG. 13 thermo compression plates 220, 230 may be applied to opposing sides of the optical package to heat and force photonics die 10 to the interposer. The heat of the thermo compression plates may reflow solder associated with contacts 30,10 thereby making an electrical connection with respective photonics die 10 contacts and interposer contacts 53.

As shown in FIG. 14, a curable adhesive 48 (e.g., UV adhesive, etc.) may be applied to the coupling region upon the external waveguide 48. The cured adhesive 48 may mechanically strengthen the bond between external waveguide 40 and photonics die 10 and reduce strain between the adiabatic coupled waveguides of external waveguide 40 and photonics die 10. Also shown in FIG. 14 is an internal view of waveguide 40 which may include an inner core 46 surrounded by cladding 44 surrounded by outer shell 42. Inner core 46 may include one or more waveguides 45, as shown in FIG. 15, which may be adiabatically coupled to respective internal waveguides of photonic die 10. External waveguide 40 may also include locating features 43 (e.g. fiducials, etc.) for ferrule 58 alignment for proper optical connection of ferrule 58 with waveguide 40. Further, the internal waveguides 45 themselves may be utilized to properly align external waveguide 40 with ferrule 58.

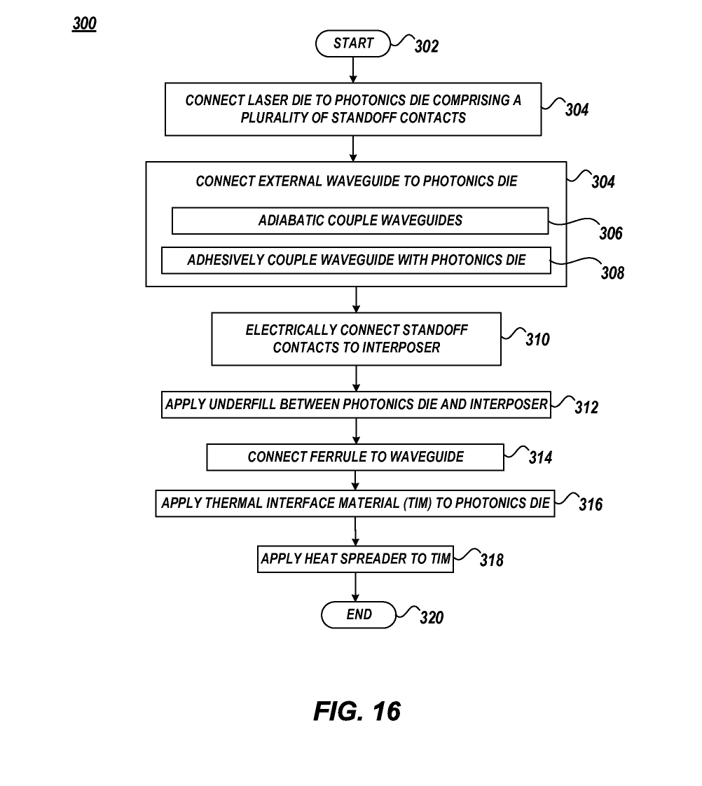

FIG. 16 depicts an optical packaging method 300, in accordance with various embodiments of the present invention. Method 300 begins at block 302 and continues with optically connecting and electrically connecting laser die 20 with photonics die 10 (block 304). For example, the laser die 20 may be wire bonded to photonics die 10 to provide for the electrical connection and one or more facets may be aligned with internal waveguides of photonics die 10 to provide for the optical connection.

Method 300 may continue with connecting external waveguide 40 to photonics die 10 (block 304). For example, the waveguide 40 may be optically connected to photonics die 10 by adiabatically coupling respective waveguides 45 with internal waveguides within photonics die 10 (block 306). An adhesive may be applied externally to waveguide 40 in the adiabatic coupling region of waveguide 40 to reduce strain upon the adiabatic couplers (block 308).

Method 300 may continue with electrically connecting standoff contacts 30 to interposer contacts 53 (block 310). For example, reflowed solder may electrically connect standoff contacts 30 with interposer contacts 53. Method 300 may continue by applying underfill 60 between the photonics die 10 and interposer 50 and between waveguide 40 and interposer 50 surrounding standoff contacts 30 (block 312).

Method 300 may continue with optically connecting ferrule 58 with waveguide 40 (block 314). For example, the ferrule 58 may be aligned with waveguide 40 utilizing locating features 43 or the waveguides 45 to optically connect ferrule 58 and waveguide 40. The ferrule 58 allows for respective optical fibers to make optical contact with associated waveguides 45. Method 300 may continue with applying a thermal interface material to side surface 15 of photonics die 10 (block 316) and applying a heat spreading device, e.g., heat sink, lid, cover, etc. to the thermal interface material (block 318). Method 300 ends at block 320.

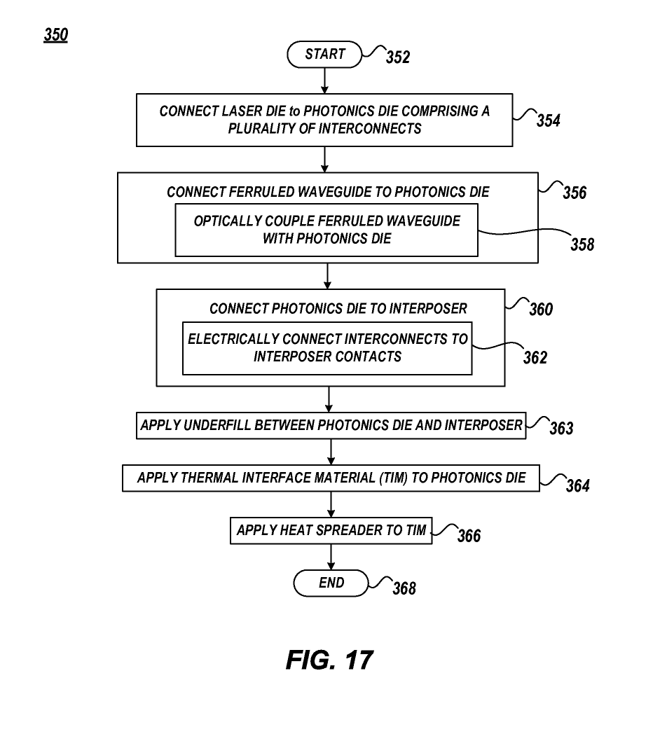

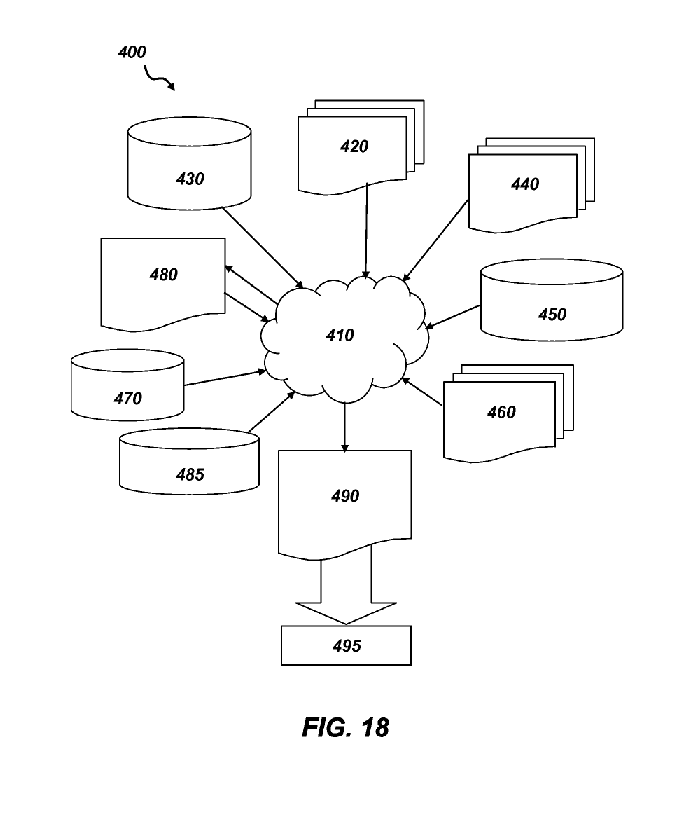

FIG. 17 depicts an optical packaging method 350, in accordance with various embodiments of the present invention. Method 350 begins at block 352 and continues with optically connecting and electrically connecting laser die 20 with photonics die 10 (block 354). For example, the laser die 20 may be wire bonded to photonics die 10 to provide for the electrical connection and one or more facets may be aligned with internal waveguides of photonics die 10 to provide for the optical connection.

Method 350 may continue with connecting ferruled waveguide 110 to photonics die 10 (block 354). For example, the ferruled waveguide 110 may be optically connected to photonics die 10 by adiabatically coupling respective waveguides 45 with internal waveguides within photonics die 10 (block 356).

Method 350 may continue with electrically connecting FR contacts 100 to interposer 55 contacts 53 (block 360). For example, reflowed solder may electrically connect FR contacts 100 with interposer 55 contacts 53 (block 362). Method 350 may continue by applying underfill 120 between the photonics die 10 and interposer 55 and between waveguide 40 and interposer 55 surrounding FR contacts 100 (block 363). Method 350 may continue with applying a thermal interface material to side surface 15 of photonics die 10 (block 364) and applying a heat spreading device e.g., heat sink, lid, cover, etc. to the thermal interface material (block 366). Method 350 ends at block 368.

Referring now to FIG. 18, a block diagram of an exemplary design flow 400 used for example, in semiconductor integrated circuit (IC) logic design, simulation, test, layout, and/or manufacture is shown. Design flow 400 includes processes, machines and/or mechanisms for processing design structures or devices to generate logically or otherwise functionally equivalent representations of the structures and/or devices described above and shown in FIGS. 1-15.

The design structures processed and/or generated by design flow 400 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 400 may vary depending on the type of representation being designed. For example, a design flow 400 for building an application specific IC (ASIC) may differ from a design flow 400 for designing a standard component or from a design flow 400 for instantiating the design into a programmable array, for example a programmable gate array (PGA) or a field programmable gate array (FPGA) offered by Altera® Inc. or Xilinx® Inc.

FIG. 18 illustrates multiple such design structures including an input design structure 420 that is preferably processed by a design process 410. Design structure 420 may be a logical simulation design structure generated and processed by design process 410 to produce a logically equivalent functional representation of a hardware device. Design structure 420 may also or alternatively comprise data and/or program instructions that when processed by design process 410, generate a functional representation of the physical structure of a hardware device. Whether representing functional and/or structural design features, design structure 420 may be generated using electronic computer-aided design (ECAD) such as implemented by a core developer/designer.

When encoded on a machine-readable data transmission, gate array, or storage medium, design structure 420 may be accessed and processed by one or more hardware and/or software modules within design process 410 to simulate or otherwise functionally represent an electronic component, circuit, electronic or logic module, apparatus, device, structure, or system such as those shown in FIGS. 1-15. As such, design structure 420 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 410 preferably employs and incorporates hardware and/or software modules for synthesizing, translating, or otherwise processing a design/simulation functional equivalent of the components, circuits, devices, or structures shown FIGS. 1-15 to generate a Netlist 480 which may contain design structures such as design structure 420. Netlist 480 may comprise, for example, compiled or otherwise processed data structures representing a list of wires, discrete components, logic gates, control circuits, I/O devices, models, etc. that describes the connections to other elements and circuits in an integrated circuit design. Netlist 480 may be synthesized using an iterative process in which netlist 480 is resynthesized one or more times depending on design specifications and parameters for the device. As with other design structure types described herein, netlist 480 may be recorded on a machine-readable data storage medium or programmed into a programmable gate array. The storage medium may be a non-volatile storage medium such as a magnetic or optical disk drive, a programmable gate array, a compact flash, or other flash memory. Additionally, or in the alternative, the storage medium may be a system or cache memory, buffer space, or electrically or optically conductive devices in which data packets may be intermediately stored.

Design process 410 may include hardware and software modules for processing a variety of input data structure types including Netlist 480. Such data structure types may reside, for example, within library elements 430 and include a set of commonly used elements, circuits, and devices, including models, layouts, and symbolic representations, for a given manufacturing technology (e.g., different technology nodes, 32 nm, 45 nm, 90nm, etc.). The data structure types may further include design specifications 440, characterization data 450, verification data 460, design rules 470, and test data files 485 which may include input test patterns, output test results, and other testing information. Design process 410 may further include, for example, standard mechanical design processes such as stress analysis, thermal analysis, mechanical event simulation, process simulation for operations such as casting, molding, and die press forming, etc.

One of ordinary skill in the art of mechanical design can appreciate the extent of possible mechanical design tools and applications used in design process 410 without deviating from the scope and spirit of the invention claimed herein. Design process 410 may also include modules for performing standard circuit design processes such as timing analysis, verification, design rule checking, place and route operations, etc.

Design process 410 employs and incorporates logic and physical design tools such as HDL compilers and simulation model build tools to process design structure 420 together with some or all of the depicted supporting data structures along with any additional mechanical design or data (if applicable), to generate a second design structure 490. Design structure 490 resides on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures).

Similar to design structure 420, design structure 490 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-15. In one embodiment, design structure 490 may comprise a compiled, executable HDL simulation model that functionally simulates the devices shown in FIGS. 1-15.

Design structure 490 may also employ a data format used for the exchange of layout data of integrated circuits and/or symbolic data format (e.g. information stored in a GDSII (GDS2), GL1, OASIS, map files, or any other suitable format for storing such design data structures). Design structure 490 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 1-15. Design structure 490 may then proceed to a stage 495 where, for example, design structure 490: proceeds to tape-out, is released to manufacturing, is released to a mask house, is sent to another design house, is sent back to the customer, etc.

The accompanying figures and this description depicted and described embodiments of the present invention, and features and components thereof. Those skilled in the art will appreciate that any particular nomenclature used in this description was merely for convenience, and thus the invention should not be limited by the specific process identified and/or implied by such nomenclature. Therefore, it is desired that the embodiments described herein be considered in all respects as illustrative, not restrictive, and that reference be made to the appended claims for determining the scope of the invention.

The exemplary methods and structures described herein may be used in the fabrication of integrated circuit modules or packages. The package may be a single chip package or a multichip package. The chip is then integrated with other chips, discrete circuit elements and/or other signal processing devices as part of either (a) an intermediate product, such as a motherboard, or (b) an end product. The end product can be any product that includes the package, ranging from toys and other low-end applications to advanced computer products having numerous components, such as a display, a keyboard or other input device and/or a central processor, as non-limiting examples.

References herein to terms such as “vertical”, “horizontal”, etc. are made by way of example, and not by way of limitation, to establish a frame of reference. The term “horizontal” as used herein is defined as a plane parallel to the surface 11 of the photonics die 10, regardless of the actual spatial orientation of the photonics die. The term “vertical” refers to a direction perpendicular to the horizontal, as just defined. Terms, such as “on”, “above”, “below”, “side” (as in “sidewall”), “higher”, “lower”, “over”, “beneath” and “under”, are defined with respect to the horizontal plane. It is understood that various other frames of reference may be employed for describing the present invention without departing from the spirit and scope of the present invention.

The invention claimed is:

1. An optical package comprising:
a laser die that generates light, the laser die comprising a light emitting facet, and;
a photonics die that modulates light emitted from the light emitting facet, the photonics die comprising an internal waveguide optically connected with the laser facet and a plurality of standoff contacts.

2. The optical package of claim 1,
wherein the laser die comprises:
a device side surface and a backside surface opposing the device side surface, and
wherein the photonics die comprises:
a device side surface and a backside surface opposing the device side surface.

3. The optical package of claim 2, wherein the device side surface of the laser die is electrically connected and optically connected to the device side surface of the photonics die.

4. The optical package of claim 3, wherein the plurality of standoff contacts are electrically connected to the device side surface of the photonics die.

5. The optical package of claim 4, wherein the plurality of standoff contacts extend beyond the laser die backside surface.

6. The optical package of claim 1, further comprising:
an external waveguide comprising an integrated waveguide adiabatically coupled to the photonic die internal waveguide.

7. The optical package of claim 6, further comprising:
an interposer comprising a plurality of pads in respective electrical contact with the plurality of standoff contacts.

8. The optical package of claim 7, further comprising:
underfill between the photonics die and the interposer and between the external waveguide and the interposer surrounding the plurality of standoff contacts.

9. The optical package of claim 6, further comprising:
a ferrule comprising an optical fiber interface optically connected to the integrated waveguide.

10. An optical package package comprising:
a laser die that generates light, the laser die comprising a light emitting facet, and;
a photonics die that modulates light emitted from the light emitting facet, the photonics die comprising an internal waveguide optically connected with the laser facet and a plurality of flush or recessed (FR) contacts.

11. The optical package of claim 10,
wherein the laser die further comprises:
a device side surface and a backside surface opposing the device side surface, and
wherein the photonics die further comprises:
a device side surface and a backside surface opposing the device side surface.

12. The optical package of claim 11, wherein the device side surface of the laser die is electrically connected and optically connected to the device side surface of the photonics die.

13. The optical package of claim 12, wherein the plurality of FR contacts are electrically connected to the device side surface of the photonics die.

14. The optical package of claim 13, wherein the plurality of FR contacts are coplanar with the laser die backside surface or are recessed from the laser die backside surface, respectively.

15. The optical package of claim 10, further comprising:
an external waveguide comprising an integrated waveguide adiabatically coupled to the photonic die internal waveguide.

16. The optical package of claim 6, further comprising:
a recessed interposer comprising a plurality of pads in respective electrical contact with the plurality of FR contacts, a laser die recess, and an external waveguide recess.

17. The optical package of claim 16, further comprising:
underfill between the photonics die and the recessed interposer and between the external waveguide and the recessed interposer surrounding the plurality of FR contacts.

18. The optical package of claim 15, further comprising:
a ferrule comprising an optical fiber interface optically connected to the integrated waveguide.

19. An optical packaging method comprising:
optically connecting and electrically connecting a device side surface of a laser die to a device side surface of a photonics die comprising an internal waveguide and a plurality of standoff contacts extending from the photonics die device side surface, and;
adiabatically coupling an external waveguide with the photonic die internal waveguide.

20. The optical packaging method of claim 19, wherein the plurality of standoff contacts extend beyond the laser die from the photonics die device side surface.
